(19) United States
(12) Patent Application Publication
(10) Pub. No.: US 2025/0289279 A1
(43) Pub. Date: Sep. 18, 2025

(54) RUBBER ISOLATED SPHERICAL SHOCK/STRUT MOUNT

(71) Applicant: Fox Factory, Inc., Duluth, GA (US)

(72) Inventor: Jeff Wehr, Mooresville, NC (US)

(21) Appl. No.: 18/905,483

(22) Filed: Oct. 3, 2024

Related U.S. Application Data
(60) Provisional application No. 63/566,472, filed on Mar. 18, 2024.

(51) Int. Cl. B60G 15/06

(52) U.S. Cl. CPC B60G 15/067; B60G 2202/143; B60G 2204/128; B60G 2206/42; B60G 2206/80

(57) ABSTRACT

An isolated spherical shock/strut mount assembly is provided. The assembly may include an isolator and a spherical bearing coupled within the isolator. The assembly may further include a bearing housing receiving the isolator and spherical bearing within the housing. A mounting plate may be coupled to the bearing housing, wherein the isolator and spherical bearing are retained within the bearing housing in response to coupling the mounting plate to the bearing housing. The isolator may include a spherical bearing mount coupled within an over-molding portion. The over-molding portion may be formed of rubber. The assembly may further include one or more stiffeners removably coupled to the over-molding portion of the isolator, wherein coupling the one or more stiffeners to the over-molding portion of the isolator increases an effective durometer of the over-molding portion.

### CROSS REFERENCE TO RELATED APPLICATION(S)

This application claims priority to U.S. Provisional Patent Application entitled “RUBBER ISOLATED SPHERICAL SHOCK/STRUT MOUNT,” Ser. No. 63/566,472, filed Mar. 18, 2024, the disclosure of which is hereby incorporated entirely herein by reference.

### BACKGROUND OF THE INVENTION

### Technical Field

This invention relates generally to an axial shock/strut mount and more particularly to a rubber isolated spherical shock/strut mount.

### State of the Art

Current bearing mounts have either no isolation or rubber isolators. These conventional bearing mounts may create side load with misalignment. Noise, vibration, and harshness (“NVH”) can become an issue resulting from shock/struts of a vehicle. Noise is simply an unpleasant sound emitted from a vehicle during operation of that vehicle. Vibration is an actual physical feeling that can be felt through the vehicle. Harshness is an impact vibration that is typically abrupt or short in duration such as over bumps and so forth. One source of NVH can be the shocks/struts of the vehicle. There currently is not a means of dampening the NVH through a shock/strut mount.

Accordingly, there is a need for a rubber isolated spherical shock/strut mount.

### SUMMARY OF THE INVENTION

An embodiment includes an isolated spherical shock/strut mount assembly comprising: an isolator; a spherical bearing coupled within the isolator; a bearing housing receiving the isolator and spherical bearing within the bearing housing; and a mounting plate, wherein the isolator and the spherical bearing are retained within the bearing housing in response to coupling the mounting plate to the bearing housing.

The isolator may comprise a spherical bearing mount coupled within an over-molding portion. The over-molding portion may be formed of rubber. The assembly may further comprise one or more stiffeners removably coupled to the over-molding portion of the isolator, wherein the coupling the one or more stiffeners to the over-molding portion of the isolator increases an effective durometer of the over-molding portion. The spherical bearing mount may comprise a spherical bearing mount aperture extending through the spherical bearing mount. The spherical bearing mount may comprise a lip on one end of the spherical bearing mount and extending radially into the aperture. The spherical bearing mount may comprise a lock washer channel formed in the spherical bearing mount and located in an inner surface and at another end of the spherical bearing mount opposite the one end of the spherical bearing mount having the lip. The spherical bearing mount may comprise a protrusion extending radially from an outer surface of the spherical bearing mount to couple the over-molding portion to the spherical bearing mount.

The over-molding portion may comprise one or more stiffener recesses formed on a top surface and/or a bottom surface of the over-molding portion of the isolator and configured to receive the one or more stiffeners. The one or more stiffeners may be provided with a pair of vertical wall members interconnected via a bridge portion. The one or more stiffeners may be press fit into the one or more stiffener recesses. The one or more stiffeners may be invertible in order to be positioned in the top surface and/or the bottom surface of the over-molding portion of the isolator.

The over-molding portion may comprise one or more over-molding portion channels formed in an outer surface thereof and extending in an axial direction, wherein the one or more over-molding portion channels corresponds to one or more coupler receivers formed in a bearing housing recess of the bearing housing. The mounting plate may be coupled to the bearing housing via one or more bolts extending through one or more mounting plate apertures in the mounting plate and received by the one or more coupler receivers in the bearing housing.

Another embodiment includes a method of assembling an isolated spherical shock/strut mount comprising providing an isolator; coupling a spherical bearing within the isolator; receiving the isolator and the spherical bearing within a bearing housing; and retaining the isolator and spherical bearing within the bearing housing in response to coupling a mounting plate to the bearing housing.

The method may further comprise coupling a spherical bearing mount within an over-molding portion of the isolator. The over-molding portion may be formed of rubber. The method may further comprise removably coupling one or more stiffeners to the over-molding portion of the isolator, wherein the coupling the one or more stiffeners to the over-molding portion of the isolator increases an effective durometer of the over-molding portion. The method may further comprise forming one or more stiffener recesses on a top surface and/or a bottom surface of the over-molding portion of the isolator and configuring to receive the one or more stiffeners. The method may further comprise providing the one or more stiffeners with a pair of vertical wall members interconnected via a bridge portion.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of an isolator for use with an isolated spherical shock/strut mount, according to an embodiment;

FIG. 2 is a perspective, sectional view of an isolator for use with an isolated spherical shock/strut mount, according to an embodiment;

FIG. 3 is a bottom view of a section of an isolator for use with an isolated spherical shock/strut mount, according to an embodiment;

FIG. 4 is an exploded perspective view of an isolated spherical shock/strut mount assembly, according to an embodiment; and

FIG. 5 is a block diagram of steps of a method of assembling an isolated spherical shock/strut mount, according to an embodiment.

### DETAILED DESCRIPTION OF EMBODIMENTS OF THE INVENTION

As discussed above, embodiments of the present invention relate to a rubber isolated spherical shock/strut mount that combines a rubber isolator and a spherical bearing by over-molding a spherical bearing mount with a rubber isolator to reduce NVH.

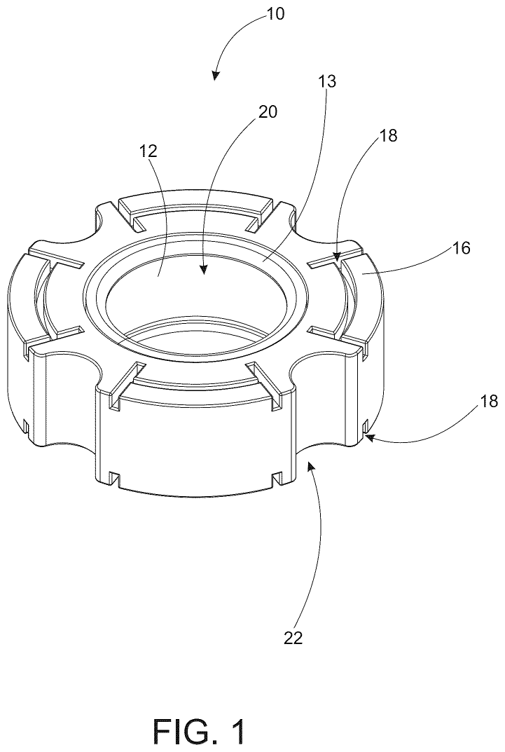

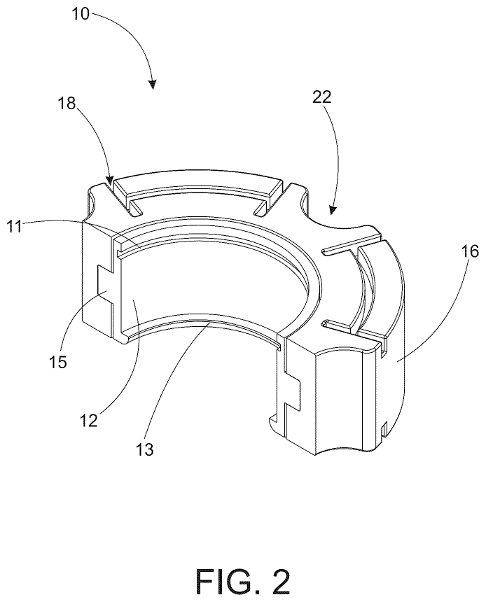

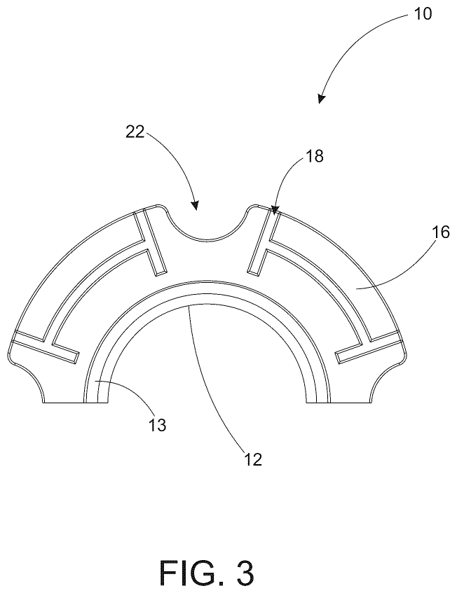

FIGS. 1-3 depict an embodiment of an isolator 10 according to an embodiment.

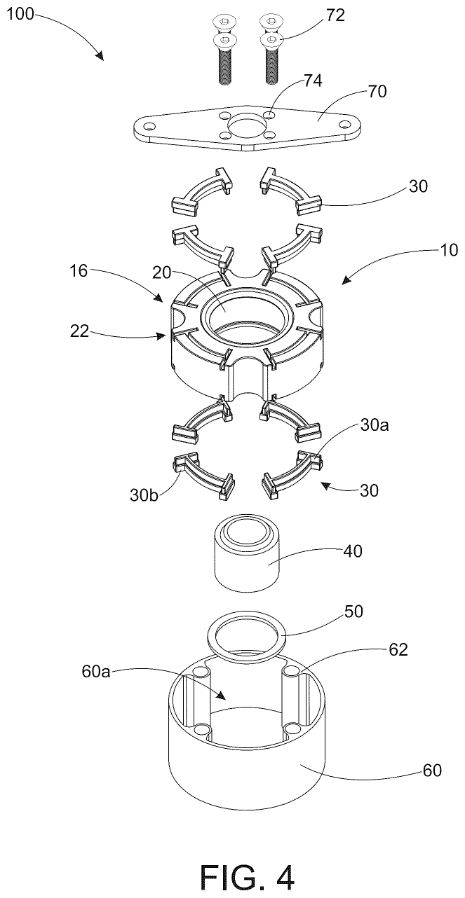

The isolator 10 may include a spherical bearing mount 12 and an over-molding portion 16. The over-molding portion 16 may be formed of rubber with an appropriate durometer to reduce NVH. The spherical bearing mount 12 may comprise an aperture 20 extending through the spherical bearing mount 12. The spherical bearing mount may include a lip 13 on one end of the spherical bearing mount 12 and extending radially into the aperture 20. The spherical bearing mount 12 may also include a lock washer channel 11 formed in the spherical bearing mount 12 and located in the inner surface and at an end of the spherical bearing mount 12 opposite the end of the spherical bearing mount 12 having the lip 13. Additionally, the spherical bearing mount 12 may also include a protrusion 15 extending radially from an outer surface of the spherical bearing mount 12. This protrusion operates to couple the over-molding portion 16 to the spherical bearing mount 12. The over-molding portion 16 may be formed of rubber. Additionally, the over-molding portion 16 may include stiffener recesses 18 that are sized and shaped to receive invertible stiffeners 30 (see FIG. 4). The invertible stiffeners 30 may be removably coupled within the stiffener recesses 18. The over-molding portion 16 may also include channels 22 formed in the outer surface and extend in an axial direction, wherein the channels 22 correspond to coupler receivers 62 of a bearing housing 60 (see FIG. 4).

Referring further to FIG. 4, a shock/strut mount assembly 100 may include an isolator 10, stiffeners 30, a spherical bearing 40, a bearing housing 60, and a mounting plate 70. The spherical bearing 40 may be coupled with the isolator 10, wherein the spherical bearing 40 is inserted within the aperture 20 of the spherical bearing mount 12 and engages the lip 13. A lock washer 50 may then be inserted with the lock washer channel 11 to retain the spherical bearing 40 within the spherical bearing mount 12 of the isolator 10. The isolator 10, with the spherical bearing 40 coupled within the isolator 10, may be received within the bearing housing 60. The bearing housing 60 comprises coupler receivers 62 that are formed in a recess 60a of the bearing housing 60. The channels 22 of the over-molding portion 16 of the isolator 10 correspond to the coupler receivers 62 wherein the channels 22 of the over-molding portion 16 engages the coupler receivers 62. The mounting plate 70 may then be coupled to the bearing housing 60 with bolts 72 extending through apertures 74 in the mounting plate 70 and coupling to the coupler receivers 62 of the bearing housing 60. Coupling the mounting plate 70 to the bearing housing 60 operates to retain the spherical bearing 40 and the isolator 10 within the bearing housing 60 and forms the shock/strut mount assembly 100.

The over-molding portion 16 includes stiffener recesses 18 formed on a top and bottom surface of the over-molding portion 16. As shown in FIG. 4, stiffeners 30 having a corresponding shape and size of the stiffener recesses 18 may be press fit into the stiffener recesses 18. The stiffeners 30 operate to effectively increase isolator durometer by introducing a stiff component within the body of the over-molding portion 16 and to increase the durometer in the radial direction. The stiffeners 30 are invertible to place in the top surface, the bottom surface or both surfaces in order to adjust the effective durometer of the isolator 10. Further, less stiffeners 30 may be used on only the portions of the isolator 10 that receives the greatest radial force applied to it to stiffen the over-molding portion 16 of the isolator 10. The ability to incorporate the stiffeners 30 within the over-molding portion 16 of the isolator 10 allows the isolator 10 and the shock/strut mount assembly 100 to be utilized for higher performance applications and recreational applications, wherein the stiffeners 30 utilized are for high performance applications and non-use of the stiffeners 30 is for recreational purposes. The stiffeners 30 are provided with a pair of vertical wall members 30a that are interconnected via a bridge portion 30b.

The shock/strut mount assembly 100 provides advantages over conventional shock/strut mounts. For example, the utilization of a spherical bearing 40 operates to reduce sideload through the suspension travel. Further, the use of the isolator 10 in combination with the spherical bearing 40 operates to reduce NVH through suspension travel. Further still, the isolator 10 is adjustable in effective durometer for utilization in a recreational application or in a high performance application of the shock/strut mount assembly.

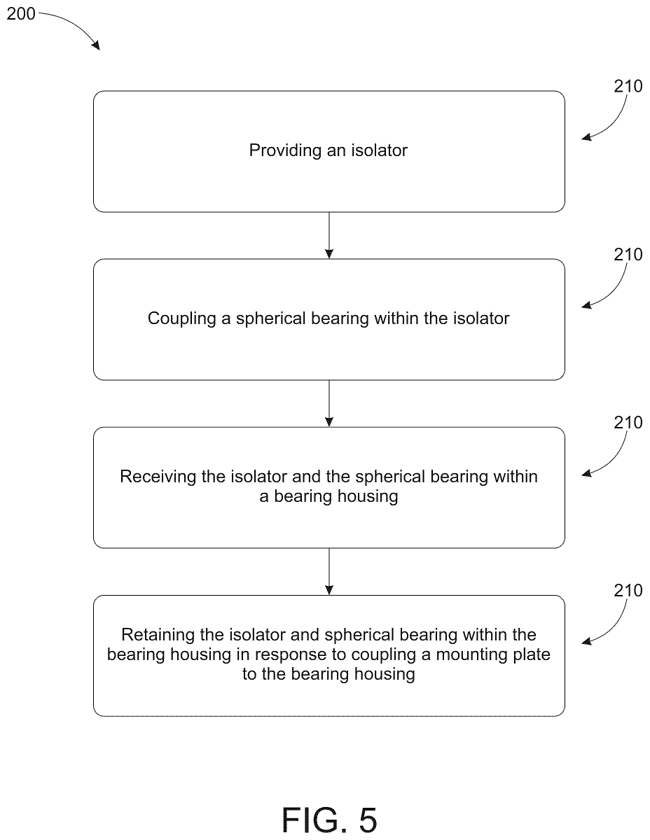

FIG. 5 is a block diagram of steps of a method 200 of assembling an isolated spherical shock/strut mount. Method 200 comprises providing an isolator (Step 210); coupling a spherical bearing within the isolator (Step 220); receiving the isolator and the spherical bearing within a bearing housing (Step 230); and retaining the isolator and spherical bearing within the bearing housing in response to coupling a mounting plate to the bearing housing (Step 240).

The method may further comprise coupling a spherical bearing mount within an over-molding portion of the isolator. The over-molding portion may be formed of rubber. The method may further comprise removably coupling one or more stiffeners to the over-molding portion of the isolator, wherein the coupling the one or more stiffeners to the over-molding portion of the isolator increases an effective durometer of the over-molding portion. The method may further comprise forming one or more stiffener recesses on a top surface and/or a bottom surface of the over-molding portion of the isolator and configuring to receive the one or more stiffeners. The method may further comprise providing the one or more stiffeners with a pair of vertical wall members interconnected via a bridge portion.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An isolated spherical shock/strut mount assembly comprising:
an isolator;
a spherical bearing coupled within the isolator;
a bearing housing receiving the isolator and spherical bearing within the bearing housing; and
a mounting plate, wherein the isolator and the spherical bearing are retained within the bearing housing in response to coupling the mounting plate to the bearing housing.

2. The assembly of claim 1, wherein the isolator comprises a spherical bearing mount coupled within an over-molding portion.

3. The assembly of claim 2, wherein the over-molding portion is formed of rubber.

4. The assembly of claim 3, further comprising one or more stiffeners removably coupled to the over-molding portion of the isolator, wherein the coupling the one or more stiffeners to the over-molding portion of the isolator increases an effective durometer of the over-molding portion.

5. The assembly of claim 2, wherein the spherical bearing mount comprises a spherical bearing mount aperture extending through the spherical bearing mount.

6. The assembly of claim 5, wherein the spherical bearing mount comprises a lip on one end of the spherical bearing mount and extending radially into the aperture.

7. The assembly of claim 6, wherein the spherical bearing mount comprises a lock washer channel formed in the spherical bearing mount and located in an inner surface and at another end of the spherical bearing mount opposite the one end of the spherical bearing mount having the lip.

8. The assembly of claim 2, wherein the spherical bearing mount comprises a protrusion extending radially from an outer surface of the spherical bearing mount to couple the over-molding portion to the spherical bearing mount.

9. The assembly of claim 4, wherein the over-molding portion comprises one or more stiffener recesses formed on a top surface and/or a bottom surface of the over-molding portion of the isolator and configured to receive the one or more stiffeners.

10. The assembly of claim 9, wherein the one or more stiffeners are provided with a pair of vertical wall members interconnected via a bridge portion.

11. The assembly of claim 9, wherein the one or more stiffeners are press fit into the one or more stiffener recesses.

12. The assembly of claim 9, wherein the one or more stiffeners are invertible in order to be positioned in the top surface and/or the bottom surface of the over-molding portion of the isolator.

13. The assembly of claim 2, wherein the over-molding portion comprises one or more over-molding portion channels formed in an outer surface thereof and extending in an axial direction, wherein the one or more over-molding portion channels corresponds to one or more coupler receivers formed in a bearing housing recess of the bearing housing.

14. The assembly of claim 13, wherein the mounting plate is coupled to the bearing housing via one or more bolts extending through one or more mounting plate apertures in the mounting plate and received by the one or more coupler receivers in the bearing housing.

15. A method of assembling an isolated spherical shock/strut mount comprising:
providing an isolator;
coupling a spherical bearing within the isolator;
receiving the isolator and the spherical bearing within a bearing housing; and
retaining the isolator and spherical bearing within the bearing housing in response to coupling a mounting plate to the bearing housing.

16. The method of claim 15, further comprising coupling a spherical bearing mount within an over-molding portion of the isolator.

17. The method of claim 16, wherein the over-molding portion is formed of rubber.

18. The method of claim 17, further comprising removably coupling one or more stiffeners to the over-molding portion of the isolator, wherein the coupling the one or more stiffeners to the over-molding portion of the isolator increases an effective durometer of the over-molding portion.

19. The method of claim 18, further comprising forming one or more stiffener recesses on a top surface and/or a bottom surface of the over-molding portion of the isolator and configuring to receive the one or more stiffeners.

20. The method of claim 19, further comprising providing the one or more stiffeners with a pair of vertical wall members interconnected via a bridge portion.
